(19) United States
(12) Patent Application Publication
(10) Pub. No.: US 2026/0012696 A1
(43) Pub. Date: Jan. 8, 2026

(54) Reduction or compensation of aberrations of a camera arranged behind an optical element

(71) Applicant: Continental Autonomous Mobility Germany GmbH, Ingolstadt (DE)

(72) Inventors: Michael Zint, Ulm (DE); Stefan Christmann, Geislingen an der Steige (DE); Martin Punke, Hergensweiler (DE); Stefan Bix, Baindt (DE); Stefan Rathgeb, Eitensheim (DE)

(73) Assignee: Continental Autonomous Mobility Germany GmbH, Ingolstadt (DE)

(21) Appl. No.: 19/258,754

(22) Filed: Jul. 2, 2025

(30) Foreign Application Priority Data
Jul. 8, 2024 (DE) 102024206407.6

(51) Int. Cl. H04N 23/58; G06T 7/00; G06T 7/70; H04N 17/00

(52) U.S. Cl. CPC H04N 23/58; G06T 7/0002; G06T 7/70; H04N 17/002; G06T 2207/30168

(57) ABSTRACT

A method for reducing and/or compensating for aberrations of a vehicle camera system having a camera arranged behind an optical element and an actuator which is arranged relative to the camera and/or configured in such a way that a movement of at least one component of the camera along at least one degree of freedom relative to the optical element can be controlled by the actuator. According to the method, at least one image is received from the camera, wherein the actuator is in an actuator reference position in which the at least one component of the camera has a camera reference position relative to the optical element, a current value for at least one measure of imaging quality is determined, and a camera target position relative to the optical element is determined, which camera target position corresponds to an optimized value for the at least one imaging parameter.

### CROSS REFERENCE TO RELATED APPLICATIONS

This application claims priority to German Application No. 102024206407.6, filed Jul. 8, 2024, the contents of such application being incorporated by reference herein.

### FIELD OF THE INVENTION

The present invention relates to a method for reducing and/or compensating for aberrations of a vehicle camera system, to a computer program for carrying out the method according to the invention, and to a computer program product on which the computer program is stored.

### BACKGROUND OF THE INVENTION

Today's driver assistance systems (Advanced Driver Assistance Systems (ADAS)) provide the driver of a vehicle with a wide range of ADAS functions which can be used on the one hand to assist the driver while the driver still remains in control of driving the vehicle. On the other hand, however, fully automated driving can also be implemented depending on the degree of automation. Examples of such ADAS functions are various methods for detecting objects or obstacles on the road, methods for detecting road boundaries and/or for keeping the vehicle in a lane, methods for detecting rain on the windshield, or methods for assisting with or performing a parking process. These and other functionalities are often at least partially based on images recorded by means of cameras attached to the vehicle.

For many common ADAS functions, capture, in particular two-dimensional or three-dimensional capture, of a vehicle environment is a necessary prerequisite. Sensor systems used for this task often include one or more cameras for capturing the environment of the vehicle. Corresponding cameras typically comprise a light-sensitive image sensor for receiving electromagnetic radiation, in particular visible light and/or infrared radiation, and for generating a camera image and further components, such as a lens.

In addition to systems with single cameras or mono cameras, camera systems with multiple cameras, such as stereo camera systems or surround view camera systems, are often used.

A stereo camera system comprises at least two, often identically designed, cameras which can be set up, for example, as separate optical systems. These two cameras are arranged relative to each other in such a way that their viewing windows partially overlap. Numerous variants have become known for the precise arrangement of the two cameras on the vehicle. For example, a possible arrangement for the cameras of a stereo camera system has been described in DE102016217450A1, which is incorporated herein by reference.

A surround view camera system comprises a multiplicity of cameras which are positioned differently relative to the vehicle. Individual cameras can capture, for example, an area in front of the vehicle, beside the vehicle, behind the vehicle and/or under the vehicle. An artificial view or top view of the vehicle can be generated from the image data from the various cameras, for example by projecting the image data onto a projection base. DE102019207415A1, for example, and incorporated herein by reference, describes a method for generating an image of a vehicle environment based on projections of the images received from a multiplicity of cameras onto a virtual projection surface in a virtual 3D space. Further methods for generating different views of vehicle environments using camera images have become known, for example, from the documents WO2018072793A1, WO2019170202A1, DE102015221340B4, DE102015221356B4, DE102016223391A1 and DE 10 2021 207 558 A1, each of which are incorporated herein by reference.

The achievable image quality, which is of decisive importance in many cases, depends, among other things, on the respective installation situation. Installation inside the vehicle is particularly advantageous in that the camera is not exposed to external influences, for example due to the respective weather conditions. On the other hand, positioning outside the vehicle has the advantage that no negative influences occur as a result of optical elements, such as a translucent pane, in particular the windshield.

### SUMMARY OF THE INVENTION

Based on this, an aspect of the present invention aims to improve the imaging quality for vehicle camera systems while at the same time having a robust arrangement relative to the vehicle.

With regard to the method, the aim on which an aspect of the invention is based is achieved by a method for reducing and/or compensating for aberrations of a vehicle camera system having a camera arranged behind an optical element and an actuator which is arranged relative to the camera and/or configured in such a way that a movement of at least one component of the camera, in particular an image sensor of the camera, along at least one degree of freedom relative to the optical element can be controlled by means of the actuator.

The at least one camera is arranged behind the optical element and inside the vehicle. The optical element is, for example, a translucent pane, or a pane which is permeable to light in a wavelength range, to which wavelength range the camera is sensitive. For example, the optical element is a glass pane, for example a windshield.

The actuator is preferably connected directly or indirectly, in particular by means of a carrier element, to a component of the camera system in such a way that an optical path of light, which reaches the camera from outside the vehicle, can be changed by means of the actuator. In this context, for example, it is possible, on the one hand, for an image sensor of the at least one camera to be connected to the actuator in such a way that a position of the image sensor relative to the optical element can be changed by means of the actuator. Alternatively, however, it is also possible for the actuator to be connected to a lens of the camera system.

The actuator is arranged and/or configured in such a way that a translational movement and/or a rotational movement of the at least one component of the camera, in particular the image sensor of the camera, relative to the optical element can be controlled by means of the actuator. It is therefore possible to achieve a movement along a degree of rotational freedom, in particular those that allow a rotation about an optical axis of the camera and/or around one or more spatial directions orthogonal to the optical axis of the camera, and/or along a degree of translational freedom, in particular along a direction of the optical axis and along two directions that are orthogonal to each other and orthogonal to the optical axis.

A camera system in which the image sensor is coupled to an actuator has become known from US 2021/0354979 A1, for example, and is incorporated herein by reference. In the proposed arrangement, the image sensor can be adjusted relative to a lens of the camera via the actuator and can thereby be moved along the optical axis of the camera in order to achieve focusing on the basis of a temperature. In addition, WO 2022/115932 A1, incorporated herein by reference, describes a similar arrangement that allows the image sensor to move with up to five degrees of freedom. The actuator can be used to achieve an autofocus function as well as an increase in a resolution of the image sensor.

In the context of an aspect of the present invention, a negative influence of an optical element on the imaging quality of the camera system is reduced and/or compensated for, or the imaging quality is improved, by means of a corresponding camera system. The method according to an aspect of the invention comprises the following method steps:
receiving at least one image from the camera, wherein the actuator is in an actuator reference position in which the camera has a camera reference position relative to the optical element,
determining a current value for at least one imaging parameter, which imaging parameter is a measure of imaging quality,
determining a camera target position relative to the optical element, which camera target position corresponds to an optimized value for the at least one imaging parameter, and
outputting a control signal for the actuator in such a way that the actuator can be moved by means of the control signal into an actuator target position corresponding to the camera target position in such a manner that the at least one component of the camera is in the camera target position.

The image may be, for example, a recording of a vehicle environment, or it may be a recording of a test target, in particular a target, as is often used to calibrate camera systems. The camera target position can be determined, in particular calculated, once, or it can be determined in an iterative process.

The method can be carried out on the one hand as part of the production of the vehicle camera system or a vehicle with a corresponding camera system. However, it can also be carried out during continuous driving of the vehicle, or as part of a repair, e.g. when replacing a windshield. In particular, the method for reducing and/or compensating for aberrations can be carried out whenever a relative positioning of the at least one component of the camera system relative to the optical element has changed. In particular, it may be a computer-implemented method which can be performed on a computing unit inside or outside the vehicle.

The optimum camera target position or actuator target position can be determined on the one hand continuously or at predefinable times, in particular periodically, i.e. continuous optimization can be carried out. However, it is also possible to carry out the proposed method once or to respectively determine an optimal camera and actuator target position for different constellations. In this case, for example, the respective camera and actuator target positions can be stored and accordingly retrieved as required.

It is an advantage of the method according to an aspect of the invention that the positioning and/or orientation of the camera, or the at least one component of the camera, and the optical element can be individually adjusted. Solutions known from the prior art for compensating for the negative influence of optical elements in the optical path of a camera often use rigidly installed optical components, such as prisms. However, these cannot compensate for small deviations of the actual relative positioning and/or orientation. In addition, for optimal imaging quality, it is also necessary for deviations from an ideal situation with regard to the specific installation position and tolerances for various parameters of the optical element to be compensated for.

The imaging quality can be defined by different imaging parameters. An aspect of the invention thus includes the adjustment of the orientation of the at least one component of the camera relative to the, in particular permanently installed, optical element in such a way that at least one imaging parameter, or a combination of at least two imaging parameters, is optimized. In this way, the quality of the images recorded by way of the camera system can be significantly improved.

Thus, in a preferred configuration of the method according to an aspect of the invention, the at least one imaging parameter is an image sharpness, a residual image tilt, an astigmatism, a chromatic aberration, a coma, a contrast, a color deviation, defocusing, or a modulation transfer function. It should be noted, however, that an aspect of the present invention is by no means limited to one of the imaging parameters mentioned, but that further imaging parameters, which are a measure of the imaging quality, can also be considered within the scope of the present invention.

It is advantageous if the imaging parameter is maximized or minimized in order to determine the camera target position. Minimization of an imaging parameter is possible, in particular, for the imaging parameters of defocusing, image tilt, an astigmatism or a coma. Maximization is advantageous, in particular, for optimizing a modulation transfer function.

An advantageous configuration of the method involves taking into account position and/or orientation information relating to the optical element for determining the camera target position relative to the optical element. This may be, in particular, production and/or manufacturing parameters or data. If the optical properties of the optical element are known, these can be taken into account in the method according to an aspect of the invention. The optical properties can be determined either experimentally or by means of simulations.

It is therefore advantageous if a model is used to determine the camera target position, i.e. to determine a position and/or orientation for the at least one component of the camera, in particular the image sensor, which model is configured to determine a camera target position starting from an optical power of the optical element, an inclination of the optical element relative to an optical axis of the camera system, or parameters of the camera system.

It is advantageous if the camera target position and/or the actuator target position is/are determined in such a way that an inclination of the image sensor relative to the optical element is optimized, in particular adjusted. It has been found that an optical element inclined relative to the image position of the image sensor is one of the main sources of aberrations for a corresponding camera system.

It is also advantageous if the camera target position and/or the actuator target position is/are determined in such a way that defocusing is compensated for, in particular minimized. The same applies to the defocusing—this represents a dominant aberration for the considered constellation of a camera system that is arranged behind an optical element.

The actuator can advantageously be a MEMS-based actuator (MEMS=micro-electro-mechanical system). Such an actuator advantageously allows a precise movement of the at least one component of the camera, in particular the image sensor, of the order of magnitude of the pixels of the image sensor or even therebelow. This allows the camera target position to be determined with high precision and aberrations of the vehicle camera system to be reduced and/or compensated for.

It is further advantageous if the movement of the actuator, and thus the movement of the at least one component of the camera, relative to the optical element comprises a rotational movement about a horizontal and/or vertical axis of the camera. So-called pitch, i.e. a horizontal tilt of the at least one component, in particular the image plane of the image sensor, or so-called yaw, i.e. a vertical tilt, is thus performed.

A further advantageous configuration of the method according to an aspect of the invention involves determining at least two at least partially different image areas of the image,
wherein a current value for the at least one imaging parameter is determined for each of the at least two image areas, and
wherein the camera target position and/or the actuator target position is/are determined based on the imaging parameters in the at least two image areas.

In this way, the reduction and/or compensation of aberrations can be directed both to the overall image and to individual, in particular selected, image areas. It is therefore possible to determine on the one hand a camera target position and/or actuator target position, which represents/represent the best possible compromise for the imaging quality of the overall image, or it is possible to determine on the other hand a camera target position and/or actuator target position, which corresponds/correspond to an optimized imaging quality in a predefinable image area.

In addition, it is possible to suitably offset the values determined for the at least one imaging parameter against one another. For example, the values for the different image areas can be provided with a selected weighting. This is advantageous, in particular, if an image tilt is compensated for.

In particular, a central area or edge or corner areas of the image can be selected as image areas.

An aspect of the invention is a computer program having instructions which, when the computer program is executed by a computer, cause the computer to carry out the method according to an aspect of the invention in accordance with one of the configurations described, and by a computer program product on which the computer program according to an aspect of the invention is stored.

The method according to an aspect of the invention is preferably used for a vehicle camera system comprising at least one camera arranged behind an optical element and an actuator which is arranged relative to the camera and/or configured in such a way that a movement of at least one component of the camera, in particular an image sensor of the camera, along at least one degree of freedom relative to the optical element can be controlled by means of the actuator.

An aspect of the invention is a vehicle camera system comprising at least one camera arranged behind an optical element and an actuator which is arranged relative to the camera and/or configured in such a way that a movement of at least one component of the camera, in particular an image sensor of the camera, along at least one degree of freedom relative to the optical element can be controlled by means of the actuator, which vehicle camera system is configured to carry out the method according to an aspect of the invention in accordance with one of the described variants, and a vehicle comprising a vehicle camera system according to an aspect of the invention.

All advantages and configurations described with respect to the method according to aspects of the invention are also applicable mutatis mutandis to the computer program according to an aspect of the invention as well as to the computer program product.

### BRIEF DESCRIPTION OF THE DRAWINGS

Further advantages and configurations of the invention result from the exemplary embodiments described in connection with the following figures. In the figures:

FIG. 1 shows an exemplary configuration for a vehicle camera system for carrying out the method according to an aspect of the invention,

FIG. 2 illustrates influences of an optical element in the optical path of the vehicle camera system from FIG. 1,

FIG. 3 shows a flowchart for a possible configuration of the method according to an aspect of the invention; and

FIG. 4 relates to a vehicle having a vehicle camera system in which a camera is arranged behind the windshield and for which the method according to an aspect of the invention is carried out.

In the figures, identical elements are always provided with the same reference sign.

### DETAILED DESCRIPTION OF EXEMPLARY EMBODIMENTS

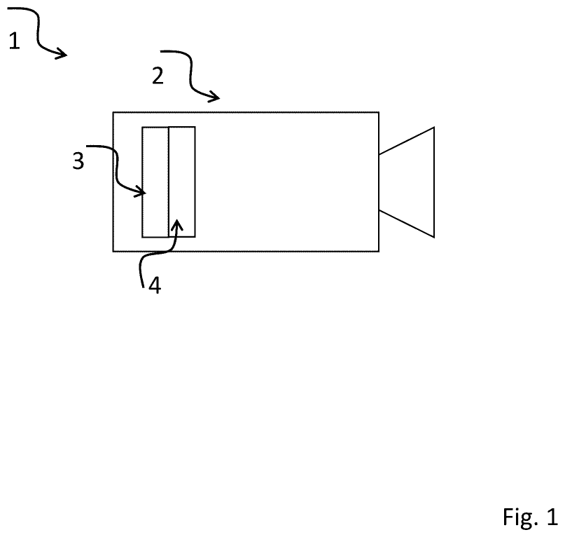

FIG. 1 illustrates, in a simplified and schematic manner, a vehicle camera system 1 comprising a camera 2 and an actuator 3. For the exemplary embodiment illustrated, the actuator 3 is connected to an image sensor 4 of the camera in such a way that a movement of the image sensor 4 of the camera 2 along at least one degree of freedom can be controlled by means of the actuator 3.

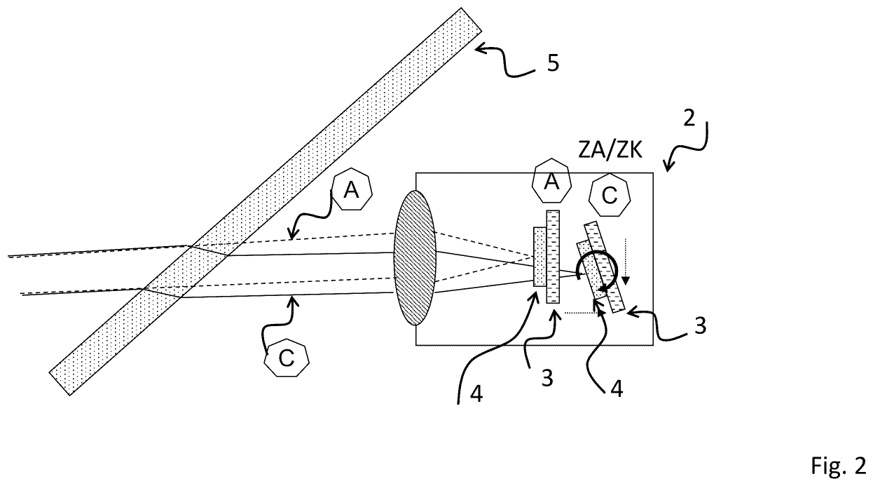

FIG. 2 illustrates how an influence of an optical element 5 in the optical path of the camera on the imaging quality can be compensated for and/or reduced. Situation (A) concerns the case where no optical element 5 is present in the optical path of the camera 2. The beam path is accordingly depicted using dashed lines.

However, if the camera 2 is arranged behind an optical element 5 (situation (C)), this leads to a change in the beam path, which is indicated for situation C using the solid lines. In order to compensate for and/or reduce negative influences of this constellation, the actuator 3 is moved according to an aspect of the invention into an actuator target position ZA which corresponds to a camera target position ZK for the image sensor 4 of the camera 2.

In the present case, the optical element 5 is at an angle to the optical axis of the camera 2, that is to say is not perpendicular to the optical axis. This is often the case, for example, for optical elements in the form of windshields of vehicles. In addition, corresponding optical elements 5, in particular also in the case of a windshield, have a local refractive power, or other optical properties which influence the imaging quality in addition to the positioning of the optical element 4. For example, the local refractive power causes defocusing in the optical path of the camera 2. The refractive power of the optical element 5 used is often known and can be taken into account accordingly in the proposed method.

If this or further information is known in advance, it can be taken into account when determining the camera target position ZK.

For the example shown here, the camera target position ZK and/or the actuator target position ZA were determined in such a way that an inclination of the image sensor 4 relative to the optical element 5 is compensated for. In particular, the image sensor 4 was tilted about a vertical axis. The method according to an aspect of the invention allows precise control of the actuator 3 into the determined, desired actuator target position ZA and thus control of at least one component of the camera 2, for example the image sensor 4, into a camera target position ZK, depending on the respective optical element 5.

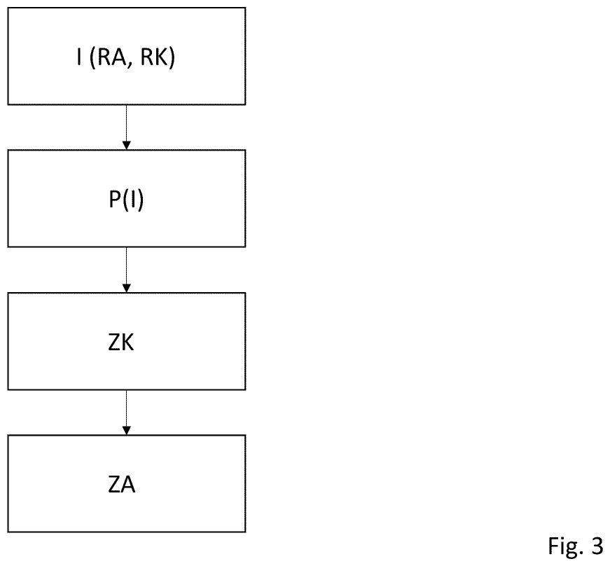

FIG. 3 shows a flowchart regarding an advantageous configuration of the method. In a first step, at least one image I(RA, RK) is recorded using the camera 2. During the recording of the image I, the actuator 3 is in an actuator reference position RA in which the at least one component of the camera 2, for example and referring to FIGS. 1 and 2 the image sensor 4, has a camera reference position RK relative to the optical element 5. A current value for at least one imaging parameter P(I) is then determined, which correlates with the imaging quality of the camera 2, i.e. is a measure of imaging quality. For example, this imaging parameter P(I) is an image sharpness, residual image tilt, an astigmatism, a chromatic aberration, a coma, a contrast, a color deviation, or a modulation transfer function.

In a third step, a camera target position ZK relative to the optical element 5 is determined and corresponds to an optimized value for the at least one image parameter P(I). The image parameter P(I) can be optimized in different ways—a certain range of values in which the current value should lie can be specified for the parameter P(I), or, for example in one possible configuration, the at least one image parameter P(I) can be maximized or minimized. A plurality of image parameters (I) can also be optimized individually or combinations of a plurality of image parameters P(I) can be optimized. The exact procedure can be made dependent on the current situation in each case.

In a final step, the actuator 3 is controlled in such a way that it is moved into an actuator target position ZA corresponding to the camera target position ZK. As a result, it is possible to record images with significantly improved imaging quality in such a way that aberrations are reduced and/or compensated for.

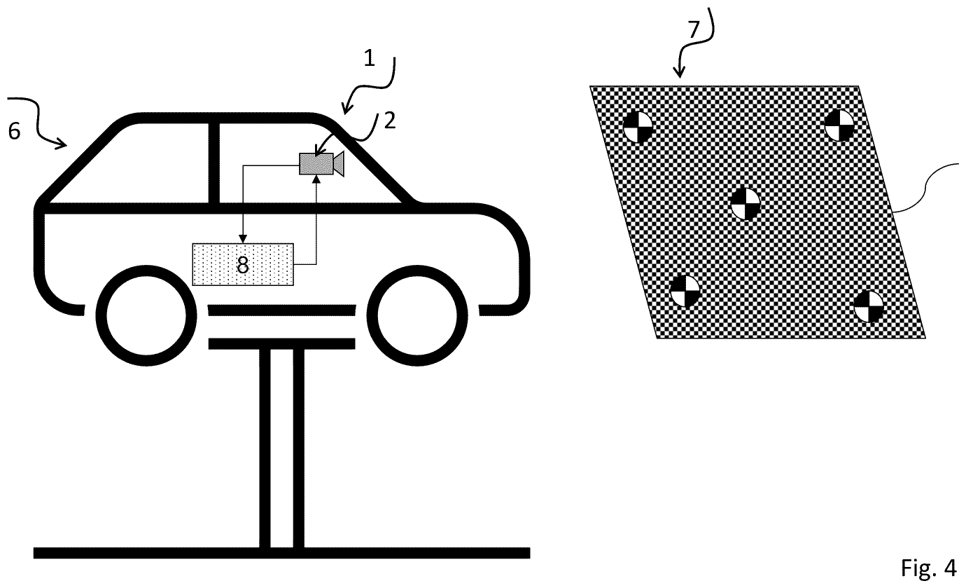

Finally, FIG. 4 shows a vehicle 6 having a vehicle camera system 1 in which a camera 2 is arranged behind the windshield 5 of the vehicle 1. The figure relates, for example, to a repair situation for a vehicle, where the windshield is replaced. An image I of a test target 7 is recorded by means of the camera 2. The test target here, for example, has a plurality of elements for measuring sharpness, and can also be used, for example, to calibrate the camera.

The accordingly recorded image I is used to carry out the method according to an aspect of the invention. This method can be carried out on the one hand in an external computing unit. However, it can also take place on a computing unit 8 inside the vehicle. In the latter case, the actuator 3 [not shown separately here] is controlled by the computing unit 8 inside the vehicle.

1. A method for reducing and/or compensating for aberrations of a vehicle camera system having a camera arranged behind an optical element and an actuator which is arranged relative to the camera and/or configured in such a way that a movement of at least one component of the camera, in particular an image sensor of the camera, along at least one degree of freedom relative to the optical element can be controlled by the actuator, the method comprising:
receiving at least one image from the camera, wherein the actuator is in an actuator reference position in which the at least one component of the camera has a camera reference position relative to the optical element,
determining a current value for at least one imaging parameter, which imaging parameter is a measure of imaging quality,
determining a camera target position relative to the optical element, which camera target position corresponds to an optimized value for the at least one imaging parameter, and
outputting a control signal for the actuator in such a way that the actuator can be moved by means of the control signal into an actuator target position corresponding to the camera target position.

2. The method as claimed in claim 1,
wherein the at least one imaging parameter is an image sharpness, a residual image tilt, an astigmatism, a chromatic aberration, a coma, a contrast, a color deviation, or a modulation transfer function.

3. The method as claimed in claim 1,
wherein the imaging parameter is maximized or minimized in order to determine the camera target position.

4. The method as claimed in claim 1,
wherein position and/or orientation information relating to the optical element is taken into account for determining the camera target position relative to the optical element.

5. The method as claimed in claim 1,
wherein the camera target position and/or the actuator target position is/are determined in such a way that an inclination of the image sensor relative to the optical element is compensated for, in particular adjusted.

6. The method as claimed in claim 1,
wherein the camera target position and/or the actuator target position is/are determined in such a way that a defocusing is compensated for, in particular minimized.

7. The method as claimed in claim 1, wherein the actuator is a MEMS-based actuator.

8. The method as claimed in claim 1,
wherein the movement of the actuator, and thus the movement of the at least one component of the camera, relative to the optical element comprises a rotational movement about a horizontal and/or vertical axis of the camera.

9. The method as claimed in claim 1,
wherein at least two at least partially different image areas of the image are determined,
wherein a current value for the at least one imaging parameter is determined for each of the at least two image areas, and
wherein the camera target position and/or the actuator target position is/are determined based on the imaging parameters in the at least two image areas.

10. A non-transitory computer program having instructions which, when the computer program is executed by a computer, cause the computer to carry out the method as claimed in claim 1.

11. A computer program product on which the computer program as claimed in claim 10 is stored.

12. The use of the method as claimed in claim 1 for a vehicle camera system having a camera arranged behind an optical element and an actuator which is arranged relative to the camera and/or configured in such a way that a movement of at least one component of the camera, in particular an image sensor of the camera, along at least one degree of freedom relative to the optical element can be controlled by means of the actuator.

13. A vehicle camera system comprising at least one camera arranged behind an optical element and an actuator which is arranged relative to the camera and/or configured in such a way that a movement of at least one component of the camera, in particular an image sensor of the camera, along at least one degree of freedom relative to the optical element can be controlled by means of the actuator, wherein the vehicle camera system is configured to carry out the method as claimed in claim 1.

14. A vehicle comprising a vehicle camera system as claimed in claim 13.

15. The method as claimed in claim 2, wherein the imaging parameter is maximized or minimized in order to determine the camera target position.
